(19) United States
(12) Patent Application Publication
(10) Pub. No.: US 2013/0286314 A1
(43) Pub. Date: Oct. 31, 2013

(54) DISPLAY ELEMENT

(71) Applicants: Keisuke Yoshida, Osaka (JP); Yasuyoshi Kaise, Osaka (JP); Masahiro Fujiwara, Osaka (JP); Hiroaki Furukawa, Osaka (JP)

(72) Inventors: Keisuke Yoshida, Osaka (JP); Yasuyoshi Kaise, Osaka (JP); Masahiro Fujiwara, Osaka (JP); Hiroaki Furukawa, Osaka (JP)

(73) Assignee: SHARP KABUSHIKI KAISHA, Osaka (JP)

(21) Appl. No.: 13/976,127

(22) PCT Filed: Dec. 20, 2011
(86) PCT No.: PCT/JP2011/079493

§ 371 Date: Jul. 15, 2013

(30) Foreign Application Priority Data
Dec. 27, 2010 (JP) 2010-290645

(51) Int. Cl. G02F 1/1368

(52) U.S. Cl. CPC G02F 1/1368
USPC 349/43

(57) ABSTRACT

A liquid crystal panel 11 of the present invention is provided with: an array substrate 20; a common wiring line 31 that is formed on the array substrate 20; a first interlayer insulating layer 39 that is formed on the common wiring line 31 and has a first contact hole 39b; a contact electrode 42 that is formed on the first interlayer insulating layer 39, is connected to the common wiring line 31 through the first contact hole 39b, and has a step section 42b that is raised onto the edge of the first contact hole 39b; a second interlayer insulating layer 40 that is formed on the contact electrode 42 and has a second contact hole 40b over the first contact hole 39b; and an opposite electrode 32 that is formed on the second interlayer insulating layer 40 and is connected to the contact electrode 42 through the second contact hole 40b. The second interlayer insulating layer 40 is formed such that an edge 40b1 of the second contact hole 40b is interposed between the step section 42b of the contact electrode 42 and the opposite electrode 32.

### TECHNICAL FIELD

The present invention relates to a display element.

### BACKGROUND ART

A liquid crystal panel used in a liquid crystal display device has a configuration in which a liquid crystal layer is sandwiched between a pair of glass substrates, and the two main types of liquid crystal panels are the VA (vertical alignment) type and the IPS (in-plane switching) type, differentiated by the direction in which the electric field is applied to the liquid crystal layer. Of these types, in an IPS-type liquid crystal panel, pixel electrodes and opposite electrodes are provided in the same layer as each other on one of the pair of glass substrates, and the orientation of the liquid crystal molecules is controlled by applying to the liquid crystal layer an electric field that is substantially parallel to the glass substrate. A so-called FFS (fringe field switching) type is a further improvement on the IPS type, in which the pixel electrodes and the opposite electrodes are disposed in different layers through an interlayer insulating layer, and slits are formed in the pixel electrodes, thus generating a fringe electric field having a component perpendicular to the surface of the glass substrate in addition to a component parallel to the surface of the glass substrate. One known example of this type of liquid crystal panel is that disclosed in Patent Document 1 below.

### RELATED ART DOCUMENT

### Patent Document

Patent Document 1: Japanese Patent Application Laid-Open Publication No. 2009-271103

### Problems to be Solved by the Invention

The liquid crystal display device disclosed in Patent Document 1 has a so-called top gate TFT. The top gate TFT has a configuration in which a semiconductor layer, a gate insulating layer, a gate electrode, a first interlayer insulating layer, and a source electrode and a drain electrode are layered in this order on a glass substrate, and on the source electrode and the drain electrode, a protective layer, an opposite electrode, a second interlayer insulating layer, and a pixel electrode are layered in this order. Of these, the drain electrode is connected to the semiconductor layer through a first contact hole formed in the first interlayer insulating layer, while the pixel electrode is connected to the drain electrode through a second contact hole formed in the second interlayer insulating layer and the protective layer, and thus, the pixel electrode is connected to the semiconductor layer of the TFT through the drain electrode.

In the liquid crystal display device disclosed in Patent Document 1, the first contact hole and the second contact hole are aligned in the horizontal direction, or in other words, the direction along the surface of the glass substrate. Thus, the drain electrode has a portion connected to the semiconductor layer therebelow and a portion connected to the pixel electrode thereabove, aligned horizontally to each other along the direction parallel to the surface of the glass substrate, which results in a tendency for the drain electrode to have a large area, thus resulting in a lower aperture ratio for the pixel.

### SUMMARY OF THE INVENTION

The present invention was made in view of the above-mentioned situation, and an object thereof is to increase the aperture ratio of the pixels.

### Means for Solving the Problems

A display element of the present invention further includes: a substrate; a first conductive layer provided on the substrate; a first insulating layer provided over the first conductive layer and having a first contact hole; a second conductive layer provided over the first insulating layer, the second conductive layer being connected to the first conductive layer through the first contact hole and having a step section raised onto an edge of the first contact hole; a second insulating layer provided over the second conductive layer and having a second contact hole positioned over the first contact hole; and a third conductive layer provided over the second insulating layer and connected to the second conductive layer through the second contact hole, wherein the second insulating layer is configured such that an edge of the second contact hole is interposed between the step section of the second conductive layer and the third conductive layer.

With this configuration, the second conductive layer is connected to the first conductive layer through the first contact hole formed in the first insulating layer, whereas the third conductive layer is connected to the second conductive layer through the second contact hole formed in the second insulating layer. As a result, the third conductive layer is connected to the first conductive layer through the second conductive layer. Here, the first contact hole and the second contact hole are disposed one over the other, and thus, the part of the second conductive layer connected to the first conductive layer corresponds in position to the part of the second conductive layer connected to the third conductive layer. Therefore, compared to a case in which the contact holes are not disposed one over the other and instead are aligned in a direction along the substrate, it is possible to make the area of the second conductive layer smaller, thus improving the aperture ratio of the pixels.

If the first contact hole and the second contact hole are disposed one over the other as described above, then there is a possibility that the third conductive layer connected to the second conductive layer through the second contact hole is layered directly on the step section of the second conductive layer raised onto the edge of the first contact hole, which causes the portion layered on the step section to have a bend, which means that the third conductive layer is susceptible to disconnections and the like. In the present invention, in the second insulating layer, the edge of the second contact hole is interposed between the step section of the second conductive layer and the third conductive layer, which prevents the third conductive layer from being directly layered on the step section. Therefore, it is possible to prevent disconnections from occurring in the third conductive layer.

As embodiments of the present invention, the following configurations are preferable.

(1) The second conductive layer has a flat first contact section in contact with the first conductive layer, whereas the third conductive layer has a flat second contact section in contact with the first contact section, and the first contact section is larger in area than the second contact section. With this configuration, between the portion of the third conductive layer raised up from the second contact section in contact with the first contact section of the second conductive layer, and the step section of the second conductive layer, a gap corresponding to the difference in area between both contact sections is ensured, which allows the edge of the second contact hole in the second insulating layer to be interposed therebetween. This makes it possible to prevent disconnection in the third conductive layer more reliably.

(2) The second insulating layer is configured such that the edge of the second contact hole covers the entire step section. With this configuration, the portion of the third conductive layer raised up from the second contact section can be reliably prevented from being directly layered on the step section, thus more reliably preventing disconnections in the third conductive layer.

(3) The step section is raised up from an entire edge of the first contact section, and the second insulating layer is configured such that the edge of the second contact hole covers the entire step section. With this configuration, the portion of the third conductive layer raised up from the second contact section can be reliably prevented from being directly layered on the step section raised up from the entire edge of the first contact section, and therefore, it is possible to more reliably prevent disconnection in the third conductive layer.

(4) The step section is raised up from an edge of the first contact section such that portions of the step section face each other, and the second contact section is disposed on the first contact section in a center between the portions of the step section facing each other. With this configuration, even if manufacturing variation were to occur in the area and position of both contact sections, it is possible to more reliably interpose the edge of the second contact hole in the second insulating layer between the portion of the third conductive layer raised up from the second contact section, and the step section with portions that face each other.

(5) The second contact section is disposed such that a center thereof matches a center of the first contact section. With this configuration, even if manufacturing variation were to occur in the area and position of both contact sections, it is possible to even more reliably interpose the edge of the second contact hole in the second insulating layer between the portion of the third conductive layer raised up from the second contact section, and the step section with portions that face each other.

(6) The second insulating layer is made of an organic material. With this configuration, compared to a case in which the second insulating layer is made of an inorganic material, the edge of the second contact hole formed in the second insulating layer becomes smoother, which makes it more difficult for disconnections to occur in the third conductive layer formed along the edge of the second contact hole. Also, from the perspective of planarizing the third conductive layer, this configuration is preferable.

(7) The second insulating layer is configured such that the edge of the second contact hole has a curved shape in a cross-sectional view. With this configuration, it is even more difficult for disconnections to occur in the third conductive layer formed along the edge of the second contact hole.

(8) A third insulating layer disposed on the third conductive layer and a fourth conductive layer disposed on the third insulating layer are further included. With this configuration, because the third conductive layer is prevented from being directly layered on the step section, thus preventing disconnections from occurring in the third conductive layer, it is possible to prevent cracks from forming in the third insulating layer formed on the third conductive layer. Therefore, it is possible to prevent short-circuiting between the third conductive layer and the fourth conductive layer with the third insulating layer interposed therebetween.

(9) At least one of the third conductive layer and the fourth conductive layer has a slit therein. With this configuration, if a difference in potential is generated between the third conductive layer and the fourth conductive layer, an electric field including a component in a direction along a surface of the substrate is applied as a result of the slit. Thus, if the substrate is disposed opposite to the opposite substrate and the liquid crystal layer is sealed between both substrates, it is possible to control the orientation of the liquid crystal molecules with the electric field with a component in the direction along the surface of the substrate, and thus, this technique is suitably applicable to a liquid crystal panel of the so-called FFS (fringe field switching) type or the like.

(10) The third conductive layer and the fourth conductive layer are both made of a transparent conductive material. With this configuration, it is possible to attain a higher aperture ratio for the pixel compared to a case in which a light-shielding metal material is used.

(11) The transparent conductive material is ITO (indium tin oxide). With this configuration, lower resistivity and excellent heat resistance, acid resistance, and alkali resistance, and the like can be attained, compared to a case in which ZnO (zinc oxide) is used, for example.

(12) The third conductive layer constitutes an opposite electrode, whereas the fourth conductive layer constitutes a pixel electrode. With this configuration, by applying a voltage between the opposite electrode and the pixel electrodes, it is possible to generate an electric field including a component in a direction along the surface of the substrate.

(13) The first conductive layer is a common wiring line that supplies a reference potential to the opposite electrode (third conductive layer) through the second conductive layer. With this configuration, the common wiring lines (first conductive layer) are connected to the opposite electrode (third conductive layer) through the second conductive layer, and thus, the reference potential can be supplied to the opposite electrode.

(14) The common wiring line is made of a light-shielding metal. With this configuration, compared to a case in which a transparent conductive material is used, the wiring resistance is lower, and thus, it is possible to prevent defects such as signal lag.

(15) A TFT constituted of a drain electrode connected to the pixel electrode that is the fourth conductive layer, a semiconductor layer having one end connected to the drain electrode, a source electrode connected to another end of the semiconductor layer, and a gate electrode that applies a gate voltage to the semiconductor layer is further included, wherein the second conductive layer is made of the same material as the drain electrode and the source electrode. With this configuration, by applying a gate voltage to the gate electrodes at a prescribed timing while supplying data signals to the source electrodes of the TFTs, it is possible for a drain current to flow between the source electrode and the drain electrode through the semiconductor layer therebetween, and as a result, it is possible to apply a prescribed potential to the pixel electrodes. Thus, an electric field based on the difference between the potential of the pixel electrode and the reference potential of the opposite electrode can be generated. According to the present invention, the second conductive layer is made of the same material as the drain electrode and the source electrode, and thus, in the manufacturing process of the display element, it is possible to form the second conductive layer in the same step as forming the drain electrode and the source electrode. Therefore, it is possible to reduce the manufacturing cost for the display element.

### Effects of the Invention

According to the present invention, it is possible to increase the aperture ratio of the pixels.

### BRIEF DESCRIPTION OF THE DRAWINGS

FIG. 1 is a schematic cross-sectional view of a liquid crystal display device according to Embodiment 1 of the present invention.

FIG. 2 is a plan view of a pixel configuration in an array substrate included in a liquid crystal panel.

FIG. 3 is a cross-sectional view along the line A-A of FIG. 2.

FIG. 4 is a cross-sectional view along the line B-B of FIG. 2.

FIG. 5 is a cross-sectional view along the line C-C of FIG. 2.

FIG. 6 is a cross-sectional view along the line D-D of FIG. 2.

FIG. 7 is a plan view of a pixel configuration in an array substrate according to Embodiment 2 of the present invention.

FIG. 8 is a cross-sectional view along the line E-E of FIG. 7.

### DETAILED DESCRIPTION OF EMBODIMENTS

### Embodiment 1

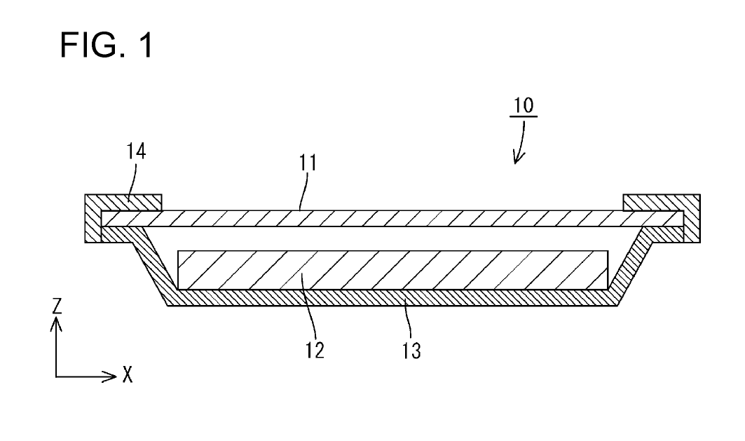

Embodiment 1 of the present invention will be described with reference to FIGS. 1 to 6. In the present embodiment, a liquid crystal display device (display device) 10 will be described as an example. The drawings indicate an X axis, a Y axis, and a Z axis in a portion of the drawings, and each of the axes indicates the same direction for the respective drawings. The up and down direction is based on that of FIG. 1, and the upper side thereof is the front side while the lower side thereof is the rear side.

First, a configuration of the liquid crystal display device 10 will be explained. As shown in FIG. 1, the liquid crystal display device 10 has a liquid crystal panel (display panel, display element) 11 that is rectangular overall in a plan view and displays images, and a backlight device (illumination device) 12 that is an external light source that radiates light towards the liquid crystal panel 11. In addition, the liquid crystal display panel 10 includes a chassis 13 that stores the backlight device 12, and a bezel 14 that holds (sandwiches) the liquid crystal panel 11 between the edge of the chassis 13 and the bezel 14. The liquid crystal display device 10 according to the present embodiment can be used in various electronic devices (not shown in drawings) such as portable information appliances (including electronic books and PDAs), mobile telephones (including smartphones), laptops, digital photo frames, and portable gaming devices. Thus, the size of the display of the liquid crystal panel 11 included in the liquid crystal display device 10 is approximately a few inches to 10 inches, for example, or in other words, small- to mid-sized in general.

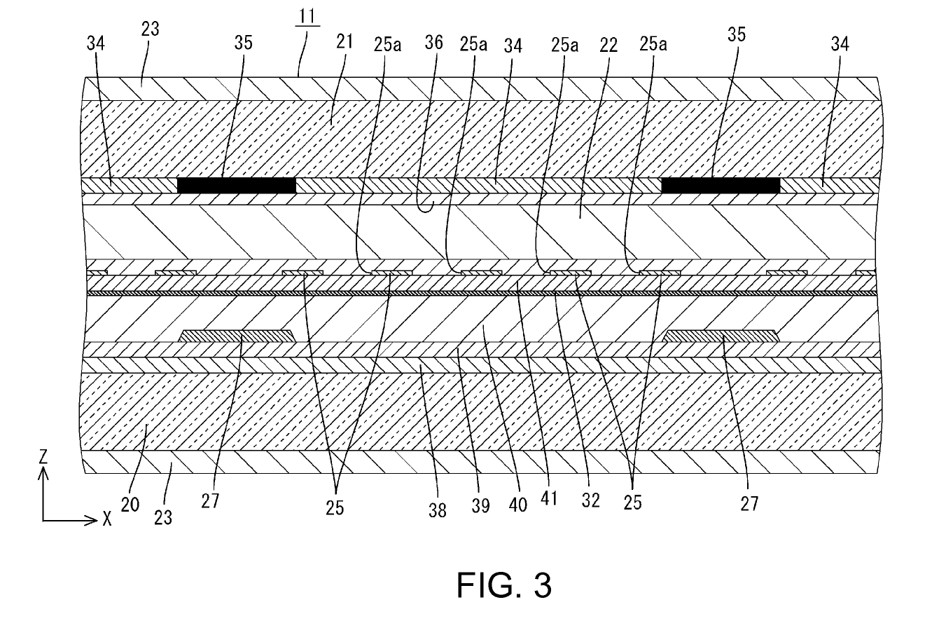

The liquid crystal panel 11 will be described. As shown in FIG. 3, the liquid crystal panel 11 includes a pair of transparent (having light-transmitting properties) glass substrates 20 and 21, and a liquid crystal layer 22, which has a liquid crystal material that changes in optical properties as a result of an applied electric field, sealed therebetween. Of the substrates 20 and 21 that constitute the liquid crystal panel 11, the rear substrate (on the side of the backlight device 12) is an array substrate (active matrix substrate) 20, and the front substrate (on the side towards which light is emitted) is an opposite substrate (CF substrate) 21. The liquid crystal panel 11 according to the present embodiment is of a fringe field switching (FFS) type, which is a further improvement on the in-plane switching (IPS) type, and has pixel electrodes 25 and an opposite electrode 32 to be described later formed on the array substrate 20 of the substrates 20 and 21, the pixel electrodes 25 and the opposite electrode 32 being disposed in different layers. A pair of polarizing plates 23 is bonded on the front and rear of the liquid crystal panel 11, respectively, on the outer surfaces of the substrates 20 and 21.

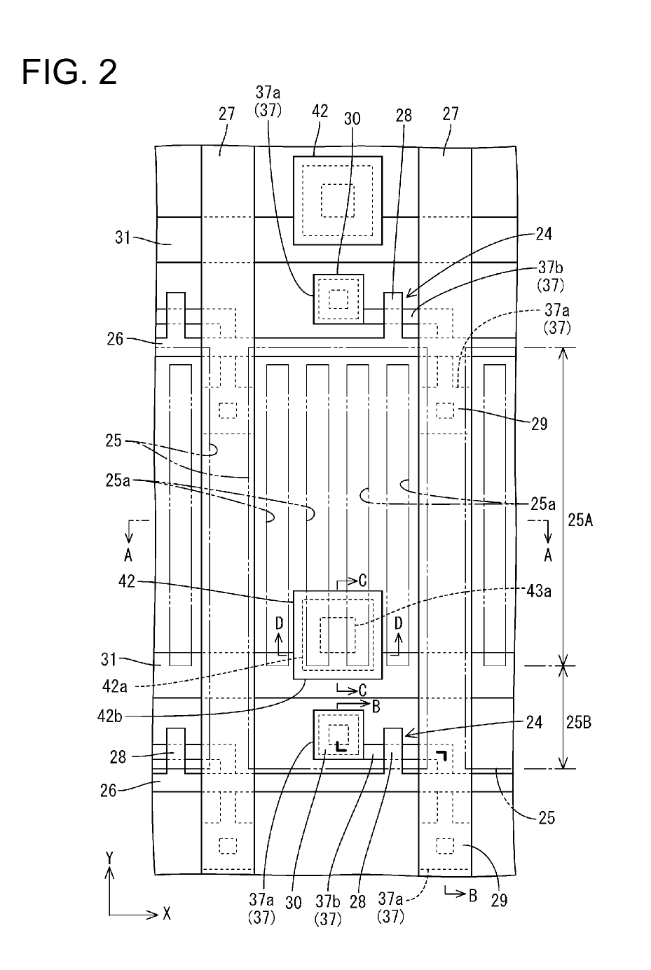

First, the array substrate 20 will be described, mainly focusing on the plan view configuration of the pixels thereof. As shown in FIG. 2, on the inner surface (liquid crystal layer 22 side, the side facing the opposite substrate 21) of the array substrate 20, a plurality of TFTs (thin film transistors) 24, which are switching elements, and a plurality of pixel electrodes 25 are provided, and a plurality of gate wiring lines 26 and source wiring lines 27 forming a grid pattern surround each TFT 24 and pixel electrode 25. One TFT 24 and one pixel electrode 25 corresponding thereto constitute one pixel. In FIG. 2, the pixel electrode 25 is depicted with a two-dot chain line. The gate wiring lines 26 have the gate electrodes 28 of the TFTs 24 to be described in detail later, whereas the source wiring lines 27 have the source electrodes 29 of the TFTs 24, and the pixel electrodes 25 are connected to the drain electrodes 30 of the TFTs 24. With this configuration, by driving the TFT 24, it is possible to apply a prescribed potential to the corresponding pixel electrode 25. The specific layered configuration of the TFT 24 will be described again below. The pixel electrode 25 is a long rectangle (a rectangle that is long in the vertical direction) in a plan view, the long side direction thereof matching the Y axis direction, the short side direction thereof matching the X axis direction. On one side of the pixel electrode 25 in the long side direction (the lower side in FIG. 2), a corresponding TFT 24 is disposed. The two long-side outer edges of the pixel electrode 25 overlap the edges of the pair of source wiring lines 27 disposed on both sides of the pixel electrode 25, and one short-side outer edge of the pixel electrode 25 overlaps a gate wiring line 26 (gate wiring line 26 on the upper side of FIG. 2) on the side opposite to the gate wiring line 26 (gate wiring line 26 on the lower side of FIG. 2) connected to the TFT 24 included in the pixel with the pixel electrode 25.

As shown in FIGS. 2 and 3, the array substrate 20 is provided with common wiring lines 31 that are parallel to the gate wiring lines 26, and an opposite electrode 32 connected to the common wiring lines 31, in addition to the gate wiring lines 26 and the source wiring lines 27. A plurality of common wiring lines 31 are provided, forming pairs with the plurality of gate wiring lines 26, the common wiring lines 31 traverse the pixel electrodes 25, and each TFT 24 is disposed between the common wiring line 31 and the gate wiring line 26. The gap between a common wiring line 31 and a gate wiring line 26 forming a pair therewith is sufficiently smaller than the gap between the common wiring line 31 and a gate wiring line 26 on the side opposite to the gate wiring line 26 that forms a pair with the common wiring line 31. A reference potential is applied to the opposite electrode 32 through the common wiring lines 31 connected thereto, and by controlling the potential applied to the pixel electrodes 25 through the TFTs 24, it is possible to control the orientation of the liquid crystal molecules included in the liquid crystal layer 22 based on the difference in potential between the electrodes 25 and 32. The connective configuration of the opposite electrode 32 to the common wiring lines 31 will be described again later. Of the pixel electrodes 25 and the opposite electrode 32, the opposite electrode 32 has a solid pattern that covers substantially the entire surface of the array substrate 20, while the pixel electrodes 25 are in a matrix, divided by the gate wiring lines 26 and the source wiring lines 27, and each pixel electrode 25 has a plurality of slits 25a (four in FIG. 2) therein, forming a substantially comb shape. The slits 25a are narrow and extend along the long-side direction (Y axis direction) of the pixel electrode 25, and are aligned along the short-side direction (X axis direction) of the pixel electrode 25 with gaps of substantially equal width therebetween. If a difference in potential occurs between the pixel electrodes 25 and the opposite electrode 32 due to the TFTs 24 being driven, a fringe electric field including a component parallel to the surface of the array substrate 20 and a component perpendicular to the surface of the array substrate 20 is applied to the liquid crystal layer 22 as a result of the slits 25a. Thus, it is possible to appropriately switch the orientation of the liquid crystal molecules included in the liquid crystal layer 22 on the slits 25a and on the pixel electrodes 25. Thus, the amount of light transmitted through the liquid crystal panel 11 can be controlled for each pixel, thus allowing a wide viewing angle and the like to be attained.

As shown in FIG. 2, the slits 25a are formed starting from the common wiring line 31 that traverses the pixel electrode 25 and ending at the gate wiring line 24 on a side opposite to the gate wiring line 26 connected to the TFT 24 that together with the pixel electrode 25 constitutes this pixel, and the range thereof is designated as a slit-forming region 25A in the pixel electrode 25. In other words, of the pixel electrode 25, the range from the common wiring line 31 that traverses that pixel electrode 25 to the gate wiring line 26 that is connected to the TFT 24 that together with the pixel electrode 25 constitutes this pixel is designated as a non-slit-forming region 25B. Between the non-slit-forming region 25B of the pixel electrode 25 and the opposite electrode 32, a sufficient storage capacitance is formed, and as a result of the storage capacitance, the potential applied to the pixel electrode 25 can be maintained for a prescribed period of time. In the non-slit-forming region 25B of the pixel electrode 25, a fringe electric field is not applied to the liquid crystal layer 22, thus not contributing to display, and therefore, a light-shielding part 35 (refer to FIG. 3) is provided extending within a range of the opposite substrate 21 (to be described later) that overlaps the non-slit-forming region 25B. In addition, a position overlapping each non-slit-forming region 25B in the pixel electrode 25 is provided with photospacers (not shown in drawings) concentrated therein and interposed between the substrates 20 and 21, setting the thickness of the liquid crystal layer 22. By disposing the photospacers in a light-shielding region that does not contribute to display as described above, even if orientation defects and the like of liquid crystal molecules occur in the vicinity of the photospacers, it is possible to avoid this having a negative impact on display.

On an edge of the array substrate 20, a terminal drawn from the gate wiring lines 26 and the common wiring lines 31 and a terminal drawn from the source wiring lines 27 are formed, and by inputting signals from external circuits that are not shown in drawings to these terminals, the driving of the TFTs 24 is controlled. On the inner surface of the array substrate 20, an alignment film 33 for orienting the liquid crystal molecules included in the liquid crystal layer 22 is formed (refer to FIG. 3).

On the other hand, as shown in FIG. 3, the inner surface of the opposite substrate 21 (on the liquid crystal layer 22 side, facing the array substrate 20) is provided with a plurality of color filters aligned so as to face the respective pixel electrodes 25 on the array substrate 20 in a plan view. As for the color filters, the colored parts 34 thereof, which are colored R (red), G (green), and B (blue), respectively, are aligned alternately along the X-axis direction. The outer shape of each colored part 34 is a rectangle with a long side being the vertical direction in a plan view, following the outer shape of each pixel electrode 25. Between each of the colored parts 34 constituting the color filters, a light-shielding part (black matrix) 35 is formed in a grid pattern in order to prevent color mixing. The light-shielding part 35 is positioned over the gate wiring lines 26 and the source wiring lines 27 on the array substrate 20 in a plan view. On the surface of each colored part 34 and the light-shielding layer 35, an alignment film 36 for orienting the liquid crystal molecules included in the liquid crystal layer 22 is formed.

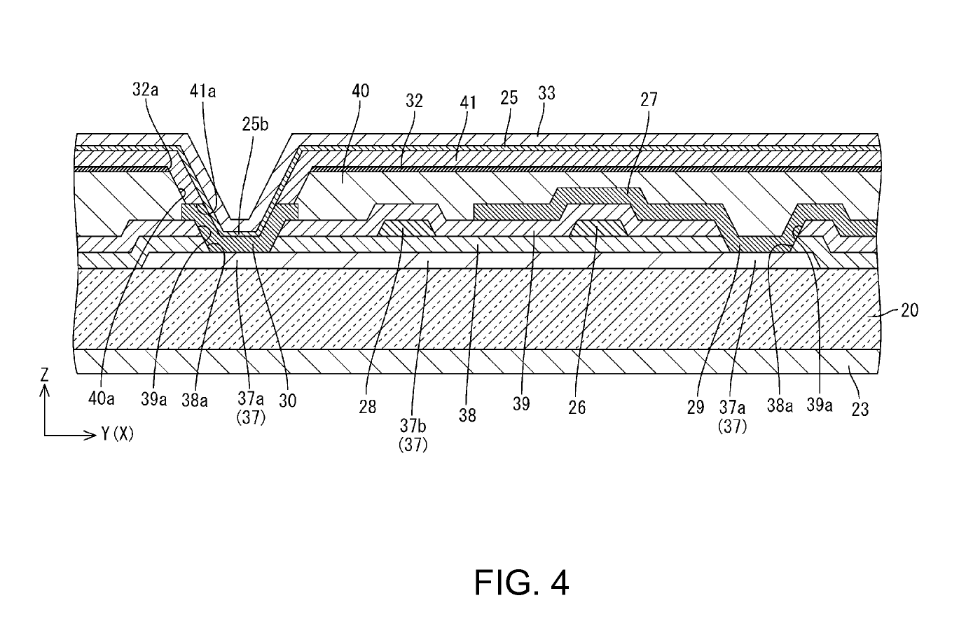

Next, the layered configuration of the TFTs 24 formed on the array substrate 20 will mainly be described in detail. As shown in FIG. 4, the TFT 24 of the present embodiment has a so-called top gate configuration (staggered type, forward staggered type) in which the gate electrode 28 is disposed over a semiconductor layer 37. Specifically, the TFT 24 has a configuration in which a plurality of films are layered on the array substrate 20, and are layered specifically in the order of the semiconductor layer 37, a gate insulating layer 38, the gate electrode 28, a first interlayer insulating layer 39, and the source electrode 29 and the drain electrode 30, from the bottom (array substrate 20 side). Additionally, on the source electrode 29 and the drain electrode 30, a second interlayer insulating layer 40, the opposite electrode 32, a third interlayer insulating layer 41, the pixel electrode 25, and the alignment film 33 are layered in this order. Each component will be described in detail below.

As shown in FIGS. 2 and 4, the semiconductor layer 37 has electrode pad sections 37a at both ends to which the source electrode 29 and the drain electrode 30 are respectively connected, and a channel section 37b that connects both electrode pad sections 37a has a substantially L shape in a plan view. The channel section 37b has a part that is parallel to the gate wiring line 26, and a part that is parallel to the source wiring line 27 and covered by the source wiring line 27. The semiconductor layer 37 is made of p-Si (polycrystalline silicon), for example, which has a much higher electron mobility than a-Si (amorphous silicon). As shown in FIG. 4, the gate insulating layer 38 is interposed between the semiconductor layer 37, and the gate electrode 28 and gate wiring line 26, keeping them insulated from each other. The gate insulating layer 38 is made of an inorganic material such as a silicon nitride (SiN_{X}), a silicon oxide (SiO_{X}), or the like.

As shown in FIGS. 2 and 4, the gate electrode 28 juts out (branches out) from the gate wiring line 26 in the Y direction, or in other words, the direction along the source wiring line 27, and overlaps approximately the center of the channel section 37b of the semiconductor layer 37 through the gate insulating layer 38. The gate electrode 28 is made of the same material as the gate wiring line 26 and the common wiring line 31 (first conductive layer), and is made in the same step as the gate wiring line 26 and the common wiring line 31 in the process of manufacturing the array substrate 20. The material thereof includes a single layer metal film or a multilayer film of a metal nitride, the metal being aluminum (Al), chromium (Cr), tantalum (Ta), titanium (Ti), copper (Cu), or the like, or in other words, a light-shielding metal having excellent conductivity.

As shown in FIG. 4, the first interlayer insulating layer (first insulating layer) 39 is interposed between the gate wiring lines 26 and the source wiring lines 27, insulating them from each other. A set of first TFT contact holes 38a and 39a is present in a position of the first interlayer insulating layer 39 and the above-mentioned gate insulating layer 38 over each of the electrode pad sections 37a of the semiconductor layer 37. The source electrode 29 and the drain electrode 30 to be described next are respectively connected to the electrode pad sections 37a of the semiconductor layer 37 through the first TFT contact holes 38a and 39a. Besides a silicon nitride (SiN_{X}), which is an inorganic material, the first interlayer insulating layer 39 can be made of a silicon oxide (SiOₓ) or the like. It is preferable that the first interlayer insulating layer 39 be made of the same material as the gate insulating layer 38.

As shown in FIGS. 2 and 4, the source electrode 29 is a portion of the source wiring line 27, or in other words, a portion of the source wiring line 27 positioned over one of the electrode pad sections 37a of the semiconductor layer 37, and the source electrode 29 is connected to one of the electrode pad sections 37a of the semiconductor layer 37 through the first TFT contact holes 38a and 39a. On the other hand, the drain electrode 30 is disposed in a position over the other electrode pad section 37a of the semiconductor layer 37, and has an island shape independent from the source wiring line 27. The drain electrode 30 is disposed in approximately the center between adjacent source wiring lines 27, which are located on both sides of the pixel electrode 25, and is connected to the other electrode pad section 37a of the semiconductor layer 37 through the first TFT contact holes 38a and 39a. The source electrode 29 and the drain electrode 30 respectively have sections (contact sections) that are substantially flat along the electrode pad sections 37a of the semiconductor layer 37 and step sections that rise up from the edge of the aforementioned sections. The source electrode 29 and the drain electrode 30 are made of the same material as the source wiring line 27, and are made in the same step as the source wiring line 27 in the process of manufacturing the array substrate 20. The material thereof includes a single layer metal film or a multilayer film of a metal nitride, the metal being aluminum (Al), chromium (Cr), tantalum (Ta), titanium (Ti), copper (Cu), or the like, or in other words, a light-shielding metal having excellent conductivity. It is preferable that the source electrode 29, the drain electrode 30, and the source wiring line 27 be made of the same material as the gate wiring line 26 (gate electrode 28) and the common wiring line 31.

As shown in FIG. 4, the second interlayer insulating layer (second insulating layer) 40 is interposed between the source wiring line 27 (source electrode 29) and drain electrode 30, and the opposite electrode 32, insulating them from each other. In a position of the second interlayer insulating layer 40 over the drain electrode 30, the second TFT contact hole 40a is formed, and the pixel electrode 25 is connected to the drain electrode 30 through the second TFT contact hole 40a. The second interlayer insulating layer 40 is made of an acrylic resin (Poly(methyl methacrylate) (PMMA), for example) or a polyimide resin, which are organic materials. Thus, the second interlayer insulating layer 40 is thicker than the interlayer insulating layers 38, 39, and 41, which are inorganic, and functions as a planarizing film.

As shown in FIG. 3, the opposite electrode (third conductive layer) 32 has a solid form that is formed on almost the entire array substrate 20, as mentioned above. The opposite electrode 32 is made of a transparent electrode material such as ITO (indium tin oxide), for example. As shown in FIG. 4, a position of the opposite electrode 32 over the drain electrode 30 has an opening 32a corresponding to the second TFT contact hole 40a. The second TFT contact hole 40a and the opening 32a have a greater opening area than a third TFT contact hole 41a to be described next.

As shown in FIG. 4, the third interlayer insulating layer (third insulating layer) 41 is interposed between the opposite electrode 32 and the pixel electrode 25, insulating them from each other. In a position of the third interlayer insulating layer 41 over the drain electrode 30, the third TFT contact hole 41a is formed, and the pixel electrode 25 is connected to the drain electrode 30 through the third TFT contact hole 41a. The third interlayer insulating layer 41 in the periphery of the third TFT contact hole 41a is formed into the second TFT contact hole 40a and the opening 32a, and is interposed between the periphery of the second TFT contact hole 40a and the opening 32a, and the pixel electrode 25. Besides a silicon nitride (SiN_{X}), which is an inorganic material, the third interlayer insulating layer 41 can be made of a silicon oxide (SiOₓ) or the like. It is preferable that the third interlayer insulating layer 41 be made of the same material as the gate insulating layer 38 and the first interlayer insulating layer 39.

As shown in FIGS. 2 and 4, a portion of the pixel electrode 25 over the drain electrode 30 (portion in the non-slit-forming region 25B) is connected to the drain electrode 30 through the third TFT contact hole 41a (the second TFT contact hole 40a and the opening 32a), and this is a TFT contact section 25b. The pixel electrode 25 is made of a transparent electrode material such as ITO (indium tin oxide), for example. It is preferable that the pixel electrode 25 be made of the same material as the opposite electrode 32. The alignment film 33 has a solid form and is formed on almost the entire array substrate 20, and is made of polyimide, for example.

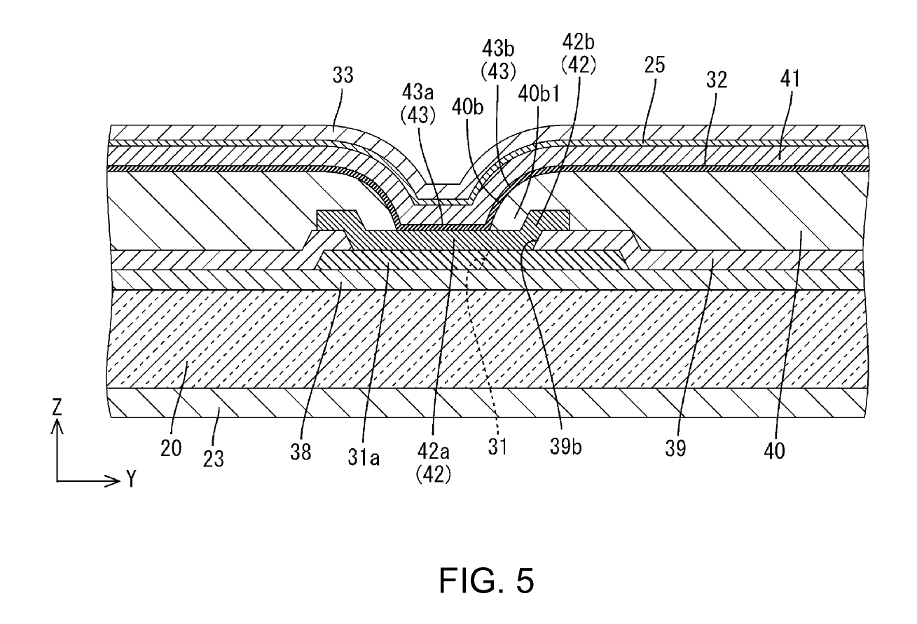

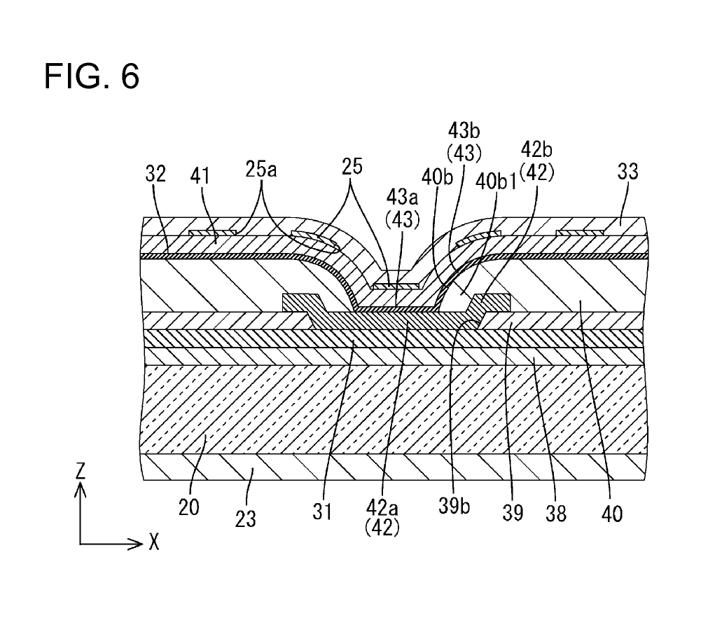

Next, the connective configuration of the common wiring lines 31 to the opposite electrode 32 will be described in detail. As shown in FIG. 2, the opposite electrode 32 is connected to the common wiring lines 31 through contact electrodes 42, and the cross-sectional configuration thereof will be mainly described in detail below. As shown in FIGS. 5 and 6, the connective configuration has a cross-sectional configuration in which the gate insulating layer 38, the common wiring line (first conductive layer) 31, the first interlayer insulating layer (first insulating layer) 39, the contact electrode (second conductive layer) 42, the second interlayer insulating layer (second insulating layer) 40, and the opposite electrode (third conductive layer) 32 are layered in this order from the bottom (array substrate 20 side). On the opposite electrode 32, the third interlayer insulating layer (third insulating layer) 41, the pixel electrode (fourth conductive layer) 25, and the alignment film 33 are additionally layered in this order. Each component will be described in detail below.

As shown in FIGS. 5 and 6, the gate insulating layer 38 has a solid pattern and is interposed between the common wiring line 31 and the array substrate 20 in the area of the gate insulating layer 38 corresponding in position to where the common wiring line 31 is connected to the opposite electrode 32.

As shown in FIGS. 2 and 5, the common wiring line 31 is provided with a pad section 31a that juts out (branches out) towards a side opposite to the side of the adjacent TFT 24 (connected to a pair of gate wiring lines 26). The pad section 31a is formed corresponding in position to a portion of the contact electrode 42, which will be mentioned later, that protrudes from the main body (broken line shown in FIG. 5) of the common wiring line 31, and has a rectangular shape that follows the outer shape of the contact electrode 42 in a plan view. The contact electrode 42 is connected to a portion of the main body and the pad section 31a of the common wiring line 31. The common wiring line 31 is made of the same material as the gate wiring line 26, and is made in the same step as the gate wiring line 26 in the process of manufacturing the array substrate 20. The material thereof includes a single layer metal film or a multilayer film of a metal nitride, the metal being aluminum (Al), chromium (Cr), tantalum (Ta), titanium (Ti), copper (Cu), or the like, or in other words, a light-shielding metal having excellent conductivity.

As shown in FIGS. 5 and 6, the first interlayer insulating layer 39 is layered on the gate insulating layer 38 and the common wiring line 31, and has the first contact hole 39b formed therein in a position over the contact electrode 42. The contact electrode 42 is connected to the common wiring line 31 and the pad section 31a thereof through the first contact hole 39b. The first contact hole 39b is formed in an area over a portion of the main body and the pad section 31a of the common wiring line 31, and has a square shape in a plan view. The first contact hole 39b has a smaller area than the contact electrode 42. The periphery of the first contact hole 39b in the first interlayer insulating layer 39 entirely overlaps the main body and the pad section 31a of the common electrode 31.

As shown in FIGS. 2, 5, and 6, the contact electrode 42 has a square shape in a plan view, and almost the entire region thereof is disposed in a position over a portion of the main body and the pad section 31a of the common wiring line 31, and is connected to the main body and the pad section 31a of the common wiring line 31 through the first contact hole 39b. Specifically, as shown in FIG. 2, the contact electrode 42 is disposed in almost the center between the source wiring lines 27 that are adjacent to each other and are on both sides of the pixel electrode 25 in the X axis direction, and is disposed towards the side opposite to the TFT 24 that is adjacent to the common wiring line 31 (the TFT 24 being connected to the gate wiring line 26 with which the common wiring line 31 forms a pair) in the Y axis direction. To describe in further detail the position of the contact electrode 42 in the Y axis direction, more than half of the contact electrode 42 juts out from the common wiring line 31 in a direction opposite to the adjacent TFT 24, whereas a portion of the contact electrode 42 covers more than half of the width of a portion of the common wiring line 31 on the side opposite to the adjacent TFT 24. The portion of the contact electrode 42 that juts out from the common wiring line 31 in the Y axis direction is connected to the already mentioned pad section 31a (refer to FIG. 5). The contact electrode 42 has an island shape independent from the source wiring line 27 and the drain electrode 30 while being disposed in the same layer as the source wiring line 27 and the drain electrode 30, and thus, by offsetting in the Y axis direction the center of the contact electrode 42 relative to the common wiring line 31 as described above, it is possible to ensure a sufficient distance between the contact electrode 42 and the drain electrode 30. Thus, even if the drain electrode 30 and the contact electrode 42 are formed closer to each other than designed due to variations in the manufacturing process, it is possible to prevent short-circuiting between the electrodes 30 and 42.

The substantially flat portion of the contact electrode 42 that enters the first contact hole 39b and is connected to the common wiring line 31 (including the pad section 31a) is the first contact section 42a as shown in FIGS. 5 and 6. As shown in FIG. 2, the first contact section 42a has a plan view shape similar to the shape of the contact electrode 42, and is a square that is slightly smaller than the contact electrode 42. The first contact section 42a is disposed so as to have the same center as that of the entire contact electrode 42. As shown in FIGS. 5 and 6, the portion of the contact electrode 42 that is on the outside of the first contact section 42a, or in other words, the outer edge thereof, is a step section 42b that overlaps the edge of the first contact hole 39b and forms a step by being raised onto this edge. The step section 42b rises from the outer edge of the first contact section 42a along the entire periphery, and is raised onto the entire peripheral portion of the first contact hole 39b. In other words, the step section 42b has a frame shape that surrounds the first contact section 42a in a plan view (refer to FIG. 2). Thus, the step section 42b rises from the edge of the first contact section 42a such that portions of the step section 42b face each other. The step section 42b has a portion that is raised inclined from the outer edge of the first contact section 42a, and a portion continuous therefrom that is horizontal again, and thus, has two bent portions. The contact electrode 42 is square in a plan view and has sides that are each approximately 10 μm, for example, the square-shaped first contact section 42a therein has sides that are each approximately 8 μm, for example, and the frame-shaped step section 42b has a width of approximately 1 μm, for example. The contact electrode 42 is made of the same material as the source wiring line 27 (source electrode 29) and the drain electrode 30 and is made in the same step as the source wiring line 27 and the drain electrode 30 in the manufacturing process of the array substrate 20. The material thereof is a single layer metal film or a multilayer film of metal nitrides, the metal being aluminum (Al), chromium (Cr), tantalum (Ta), titanium (Ti), copper (Cu), or the like. It is preferable that the contact electrode 42 be made of the same material as the gate wiring line 26 (gate electrode 28) and the common wiring line 31.

As shown in FIGS. 5 and 6, the second interlayer insulating layer 40 is layered on the first interlayer insulating layer 39 and the contact electrode 42 and has the second contact hole 40b formed therein over the first contact hole 39b and the first contact section 42a. The opposite electrode 32 is connected to the contact electrode 42 through the second contact hole 40b. The second contact hole 40b has a plan view shape similar to that of the first contact hole 39b and the first contact section 42a, and is a square slightly smaller than these. The second contact hole 40b is disposed such that the center thereof is the same as the center of the first contact hole 39b and the first contact section 42a (contact electrode 42). The edge 40b1 of the second contact hole 40b has a smooth arc shape (curve shape) in a cross-sectional view. The shape of the edge 40b1 of the second contact hole 40b can be formed with ease by heat sagging, which occurs when forming the second contact hole 40b by photolithography, because the second interlayer insulating layer 40 is made of an organic material.

As shown in FIGS. 5 and 6, the part of the opposite electrode 32 over the second contact hole 40b is a recessed section 43 that is inside the second contact hole 40b and is connected to the contact electrode 42. The recessed section 43 is constituted of a substantially flat second contact section 43a that is connected to the first contact section 42a of the contact electrode 42, and a raised section 43b that is raised onto the edge 40b1 of the second contact hole 40b from the outer edge of the second contact section 43a. As a result of the recessed section 43, the opposite electrode 32 is connected to the common wiring line 31 through the contact electrode 42, and is supplied a reference potential. Compared to a case in which the opposite electrode is directly connected to the common wiring line without interposing a contact electrode therebetween, the raised section 43b of the recessed section 43 can be given a smoother shape, thus decreasing the susceptibility of the recessed section 43 to disconnections and increasing the connective reliability.

The second contact section 43a has a plan view shape similar to the first contact hole 39b, the first contact section 42a, and the second contact hole 40b, and is a square slightly smaller than the first contact hole 39b and the first contact section 42a. As shown in FIGS. 5 and 6, the second contact section 43a is disposed such that the center thereof is the same as the center of the first contact hole 39b, the first contact section 42a (contact electrode 42), and the second contact hole 40b. The second contact section 43a that is square in a plan view has sides that are each approximately 4 μm, for example, or in other words, approximately half the length of the sides of the first contact section 43a. The raised section 43b is raised throughout the outer edge of the second contact section 43a, and is raised onto the entire edge 40b1 of the second contact hole 40b. In other words, the raised section 43b has a frame shape that surrounds the second contact section 43a in a plan view. The raised section 43b has a smooth arc shape (curved shape) in a cross-sectional view that follows the shape of the edge 40b1 of the second contact hole 40b.

As shown in FIGS. 5 and 6, the first contact hole 39b and the second contact hole 40b are disposed one inside the other in a plan view as described above, and the entire area of the second contact hole 40b, which is a relatively small opening, fits completely inside the first contact hole 39b, which is a relatively large opening. Therefore, the first contact section 42a of the contact electrode 42 (shown as the outer of the two broken lines shown inside the contact electrode 42 in FIG. 2), which is a connecting area where the contact electrode 42 is connected to the main body and the pad section 31a of the common wiring line 31, corresponds in position to the second contact section 43a of the opposite electrode 32 (recessed section 43) where the opposite electrode 32 is connected to the contact electrode 42 (shown as the inner of the two broken lines shown inside the contact electrode 42 in FIG. 2), and the entire area of the latter section is included inside the former section. Compared to a case in which the first contact hole and the second contact hole are arranged next to each other in a direction along the surface of the array substrate, and in which the first contact section in the contact electrode and a portion connected to the second contact section are similarly arranged next to each other, it is possible to have a relatively small area for the contact electrode 42. The contact electrode 42 is made of a light-shielding metal, and the area where it is formed is a light-shielding area, and thus, by making the area thereof small, the aperture ratio of the pixel can be improved.

In addition, in the present embodiment, the edge 40b1 of the second contact hole 40b in the second interlayer insulating layer 40 is interposed between the recessed section 43 in the opposite electrode 42 and the step section 42b of the contact electrode 42. Specifically, the edge 40b1 of the second contact hole 40b in the second interlayer insulating layer 40 is interposed between the raised section 43b, which is a portion of the recessed section 43 of the opposite electrode 32 that is raised from the second contact section 43a, and the step section 42b that is raised from the first contact section 42a of the contact electrode 42, over the entire periphery thereof, and the recessed section 43 is not directly layered on the step section 42b. If the recessed section of the opposite electrode were directly layered on the step section of the contact electrode, a bent portion would be formed in the layered section, which reduces the coverage of the recessed section in the bent portion, which increases the susceptibility of the recessed section to disconnection. If disconnection occurs in the recessed section, the third interlayer insulating layer thereabove is susceptible to cracking, which can cause short-circuiting between the opposite electrode and the pixel electrode. According to the present embodiment, the step section 42b is covered over the entire area thereof by the edge 40b1 of the second contact hole 40b in the second interlayer insulating layer 40, and thus, the recessed section 43 is prevented in advance from being directly raised onto the step section 42b, thus allowing disconnections in the recessed section 43 to be prevented. If disconnection in the recessed section 43 is prevented, then cracks in the third interlayer insulating layer 41 thereabove is also prevented, which can prevent the occurrence of short-circuiting between the opposite electrode 32 and the pixel electrode 25 sandwiching the third interlayer insulating layer 41. Thus, it is possible to attain a high display quality.

Furthermore, the first contact section 42a and the second contact section 43a are disposed such that the centers thereof match, and therefore, the distance between the raised section 43b of the recessed section 43 and the step section 42b in the contact electrode 42, or in other words, the thickness of the edge 40b1 of the second contact hole 40b in the second interlayer insulating layer 40 is even throughout the entire edge. Thus, even if a portion of the raised section 43b and a portion of the step section 42b were formed closer to each other than designed due to variations in manufacturing, it is possible to interpose the edge 40b1 of the second contact hole 40b in the second interlayer insulating layer 40 between the raised section 43b and the step section 42b, and therefore, it is possible to more reliably prevent the recessed section 43 from being disposed directly on the step section 42b.

As described above the liquid crystal panel (display element) 11 of the present embodiment includes: an array substrate (substrate) 20; a common wiring line 31 (first conductive layer) provided on the array substrate 20; a first interlayer insulating layer 39 (first insulating layer) provided over the common wiring line 31 (first conductive layer) and having a first contact hole 39b; a contact electrode 42 (second conductive layer) provided over the first interlayer insulating layer 39 (first insulating layer), connected to the common wiring line 31 (first conductive layer) through the first contact hole 39b, and having a step section 42b raised onto an edge of the first contact hole 39b; a second interlayer insulating layer 40 (second insulating layer) provided over the contact electrode 42 (second conductive layer) and having a second contact hole 40b positioned over the first contact hole 39b; and an opposite electrode 32 (third conductive layer) provided over the second interlayer insulating layer 40 (second insulating layer) and connected to the contact electrode 42 (second conductive layer) through the second contact hole 40b, the second interlayer insulating layer 40 (second insulating layer) being configured such that the edge 40b1 of the second contact hole 40b is interposed between the step section 42b of the contact electrode 42 (second conductive layer) and the opposite electrode 32 (third conductive layer).

With this configuration, the contact electrode 42 (second conductive layer) is connected to the common wiring line 31 (first conductive layer) through the first contact hole 39b formed in the first interlayer insulating layer 39 (first insulating layer), whereas the opposite electrode 32 (third conductive layer) is connected to the contact electrode 42 (second conductive layer) through the second contact hole 40b formed in the second interlayer insulating layer 40 (second insulating layer). With this configuration, the opposite electrode 32 (third conductive layer) is connected to the common wiring line 31 (first conductive layer) through the contact electrode 42 (second conductive layer). Here, because the first contact hole 39b and the second contact hole 40b are disposed one over the other, a portion of the contact electrode 42 (second conductive layer) connected to the common wiring line 31 (first conductive layer) corresponds in position to the portion of the contact electrode 42 that is connected to the opposite electrode 32 (third conductive layer). Thus, compared to a case in which the contact holes are not disposed one over the other and are instead aligned with respect to each other in a direction along the array substrate 20, it is possible reduce the area of the contact electrode 42 (second conductive layer), and thus, it is possible to improve the aperture ratio of the pixel.

If the first contact hole 39b and the second contact hole 40b are disposed one over the other as described above, there is a risk that the opposite electrode 32 (third conductive layer), which is connected to the contact electrode 42 (second conductive layer) through the second contact hole 40b, is directly layered onto the step section 42b of the contact electrode 42 (second conductive layer) that is raised onto the edge of the first contact hole 39b. If this happens, a bent portion or the like is formed in the portion of the opposite electrode 32 layered on the step portion 42b, which can cause disconnection or the like in the opposite electrode 32 (third conductive layer). However, in the present embodiment, the second interlayer insulating layer 40 (second insulating layer) is formed such that the edge 40b1 of the second contact hole 40b is interposed between the step section 42b of the contact electrode 42 (second conductive layer) and the opposite electrode 32 (third conductive layer). Thus, it is possible to prevent the opposite electrode 32 (third conductive layer) from being directly layered onto the step section 42b. Therefore, it is possible to prevent disconnections from occurring in the opposite electrode 32 (third conductive layer).

Also, the contact electrode 42 (second conductive layer) has the flat first contact section 42a, which is connected to the common wiring line 31 (first conductive layer), whereas the opposite electrode 32 (third conductive layer) has the flat second contact section 43a, which is connected to the first contact section 42a, and the first contact section 42a is greater in area than the second contact section 43a. With this configuration, a gap corresponding to the difference in area between the contact sections 42a and 43a is ensured between the portion of the opposite electrode 32 (third conductive layer) that is raised up from the second contact section 43a (raised section 43b), which is connected to the first contact section 42a of the contact electrode 42 (second conductive layer), and the step section 42b of the contact electrode 42 (second conductive layer). Thus, it is possible to interpose the edge 40b1 of the second contact hole 40b in the second interlayer insulating layer 40 (second insulating layer) between the raised section 43b and the step section 42b. As a result, it is possible to reliably prevent disconnection in the opposite electrode 32 (third conductive layer).

The second interlayer insulating layer 40 (second insulating layer) is configured such that the entire step section 42b is covered by the edge 40b1 of the second contact hole 40b. With this configuration, the portion of the opposite electrode 32 (third conductive layer) raised up from the second contact section 43a can be reliably prevented from being directly layered onto the step section 42b, and therefore, it is possible to more reliably prevent disconnection in the opposite electrode 32 (third conductive layer).

The step section 42b is raised up from the entire edge of the first contact section 42a, and the second interlayer insulating layer 40 (second insulating layer) is configured such that the entire step section 42b is covered by the edge 40b1 of the second contact hole 40b. With this configuration, the section of the opposite electrode 32 (third conductive layer) raised from the second contact section 43a can be reliably prevented from being directly layered on the step section 42b that is raised from the entire edge of the first contact section 42a. Thus, it is possible to more reliably prevent disconnection in the opposite electrode 32 (third conductive layer).

The step section 42b is raised up from the edge of the first contact section 42a such that portions thereof face each other, and the second contact section 43a is disposed in the center of the first contact section 42a between the portions of the step section 42b facing each other. With this configuration, even if manufacturing variation occurs in the area or position of the contact sections, it is possible to reliably interpose the edge 40b1 of the second contact hole 40b in the second interlayer insulating layer 40 (second insulating layer) between the section of the opposite electrode 32 (third conductive layer) raised up from the second contact section 43a, and the step section 42b, portions thereof facing each other.

The second contact section 43a is disposed such that the center thereof matches that of the first contact section 42a. With this configuration, even if manufacturing variation occurs in the area or position of the contact sections, it is possible to more reliably interpose the edge 40b1 of the second contact hole 40b in the second interlayer insulating layer 40 (second insulating layer) between the section of the opposite electrode 32 (third conductive layer) raised up from the second contact section 43a, and the step section 42b, portions thereof facing each other.

The second interlayer insulating layer 40 (second insulating layer) is made of an organic material. Compared to a case in which an inorganic material is used, the shape of the edge 40b1 of the second contact hole 40b formed in the second interlayer insulating layer 40 (second insulating layer) is made smoother, and thus, it is more difficult for disconnections to occur in the opposite electrode 32 (third conductive layer) formed along the edge 40b1 of the second contact hole 40b. An organic material is also preferable from the perspective of planarizing the opposite electrode 32 (third conductive layer).

The second interlayer insulating layer 40 (second insulating layer) has a curved shape in a cross-sectional view of the edge 40b1 of the second contact hole 40b. With this configuration, it is more difficult for disconnections to occur in the opposite electrode 32 (third conductive layer) formed along the edge 40b1 of the second contact hole 40b.

Also, the third interlayer insulating layer 41 (third insulating layer) formed on the opposite electrode 32 (third conductive layer) and the pixel electrodes 25 (fourth conductive layer) formed on the third interlayer insulating layer 41 (third insulating layer) are provided. With this configuration, because it is possible to prevent the opposite electrode 32 (third conductive layer) from being directly layered onto the step section 42b, thus preventing disconnections in the opposite electrode 32 (third conductive layer), the third interlayer insulating layer 41 (third insulating layer) formed on the opposite electrode 32 (third conductive layer) can also be prevented from cracking. Thus, it is possible to prevent short-circuiting between the opposite electrode 32 (third conductive layer) and the pixel electrode 25 (fourth conductive layer) sandwiching the third interlayer insulating layer 41 (third insulating layer).

At least one of the opposite electrode 32 (third conductive layer) and the pixel electrode 25 (fourth conductive layer) has slits 25a formed therein. With this configuration, when a difference in potential is generated between the opposite electrode 32 (third conductive layer) and the pixel electrode 25 (fourth conductive layer), the slits 25a cause an electric field with a component in a direction along the surface of the array substrate 20 to be applied. Thus, if the array substrate 20 is disposed opposite to the opposite substrate 21 and the liquid crystal layer 22 is sealed between the substrates 20 and 21, it is possible to control the orientation of the liquid crystal molecules with the electric field including a component in a direction along the surface of the array substrate 20, and thus, this technique is suitably applicable to a liquid crystal panel 11 of the so-called FFS (fringe field switching) type or the like.

Also, the opposite electrode 32 (third conductive layer) and the pixel electrode 25 (fourth conductive electrode) are both made of a transparent conductive material. With this configuration, it is possible to attain a higher aperture ratio for the pixel compared to a case in which a light-shielding metal material is used.

The transparent conductive material is ITO (indium tin oxide). With this configuration, lower resistivity and excellent heat resistance, acid resistance, and alkali resistance, and the like can be attained, compared to a case in which ZnO (zinc oxide) is used, for example.

The third conductive layer constitutes the opposite electrode 32, whereas the fourth conductive layer constitutes the pixel electrodes 25. With this configuration, by applying a voltage between the opposite electrode 32 and the pixel electrodes 25, it is possible to generate an electric field including a component in a direction along the surface of the array substrate 20.

The first conductive layer is the common wiring line 31 that supplies a reference potential to the opposite electrode 32 (third conductive layer) through the contact electrode 42 (second conductive layer). With this configuration, the common wiring lines 31 (first conductive layer) are connected to the opposite electrode 32 (third conductive layer) through the contact electrodes 42 (second conductive layer), and thus, the reference potential can be supplied to the opposite electrode 32.

The common wiring line 31 is made of a light-shielding metal. With this configuration, compared to a case in which a transparent conductive material is used, the wiring resistance is lower, and thus, it is possible to prevent defects such as signal lag.

The TFTs 24 are provided, each being constituted of the drain electrode 30 connected to the pixel electrode 25 (fourth conductive layer), the semiconductor layer 37 having one end connected to the drain electrode 30, the source electrode 29 connected to the other end of the semiconductor layer 37, and the gate electrode 28 that applies a gate voltage to the semiconductor layer 37. The contact electrode 42 (second conductive layer) is made of the same material as the drain electrode 30 and the source electrode 29. With this configuration, a gate voltage is applied to the gate electrode 28 at a prescribed timing in addition to supplying data signals to the source electrode 29 in the TFT 24, and thus, drain currents flow through the semiconductor layer 37 between the source electrode 29 and the drain electrode 30, which allows a prescribed potential to be applied to the pixel electrode 25. Thus, an electric field based on the difference between the potential of the pixel electrode 25 and the reference potential of the opposite electrode 32 is generated. In the present embodiment, the contact electrode 42 (second conductive layer) is made of the same material as the drain electrode 30 and the source electrode 29, and thus, in the manufacturing process of the liquid crystal panel 11, it is possible to form the contact electrode 42 (second conductive layer) in the same step as forming the drain electrode 30 and the source electrode 29. Therefore, it is possible to reduce the manufacturing cost for the liquid crystal panel 11.

### Embodiment 2

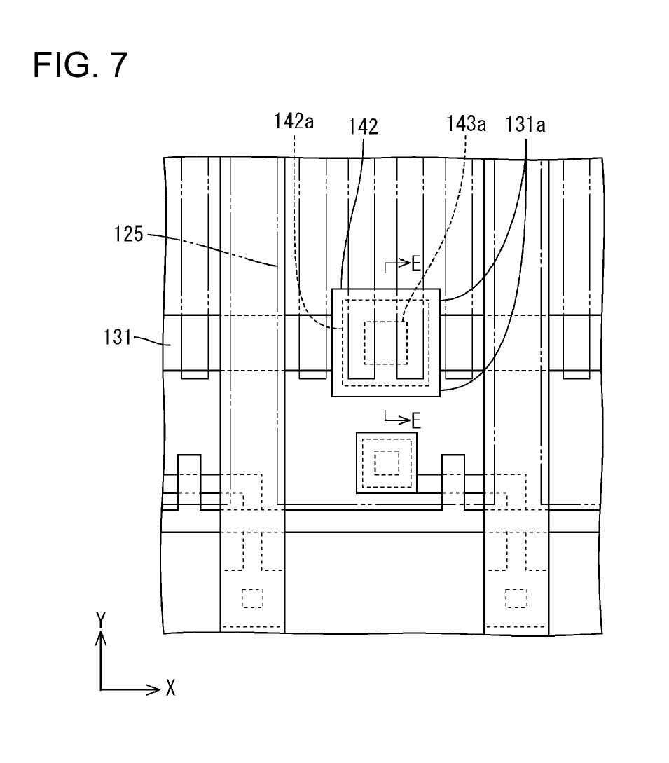

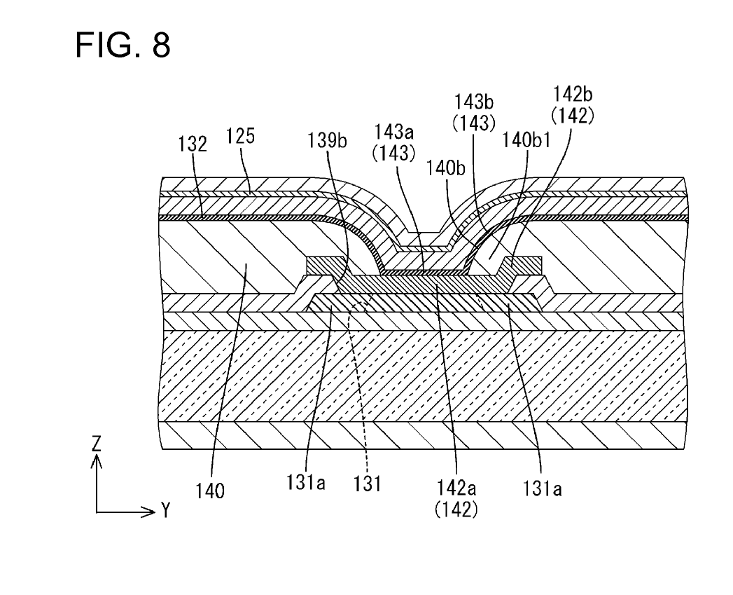

Embodiment 2 of the present invention will be described with reference to FIGS. 7 and 8. In Embodiment 2, the position of a contact electrode 142 relative to a common wiring line 131 is different. Descriptions of structures, operations, and effects similar to those of Embodiment 1 will be omitted.

As shown in FIG. 7, the contact electrode 142 has the same center as the common wiring line 131 in the Y axis direction. In the contact electrode 142, each side thereof is wider than the width of the common wiring line 131. Thus, the contact electrode 142 juts out equally from both outer edges of the common wiring line 131 in a plan view in the Y axis direction. The common wiring line 131 has a pair of pad sections 131a in positions corresponding to the jutting out portion of the contact electrode 142. A first contact section 142a in the contact electrode 142 is connected to the main body of the common wiring line 131 along the entire width thereof, and is connected to the pair of pad sections 131a formed on both sides thereof. A first contact hole b139b, a second contact hole 140b, the first contact section 142a, and a second contact section 143a are positioned such that the centers thereof all match the center of the common wiring line 131 in the Y axis direction. The entire region of the second contact hole 140b and the second contact section 143a is positioned over the main body of the common wiring line 131 in a plan view. Even with such a configuration, it is possible to improve the aperture ratio of the pixels by disposing the first contact hole 139b and the second contact hole 140b, one inside the other in a plan view. By interposing an edge 140b1 of the second contact hole 140b in the second interlayer insulating layer 140 between a raised section 143b of a recessed section 143 in the opposite electrode 142, and a step section 142b of the contact electrode 142, it is possible to prevent disconnections in the opposite electrode 132, and to prevent short-circuiting between the opposite electrode 132 and pixel electrodes 125.

### Other Embodiments

The present invention is not limited to the embodiments shown in the drawings and described above, and the following embodiments are also included in the technical scope of the present invention, for example.

(1) In the embodiments above, a case was described in which a characteristic configuration according to the present invention was applied to the connective configuration between the opposite electrode and the common wiring line, but it is also possible to apply the characteristic configuration according to the present invention to the connective configuration between the pixel electrode and the semiconductor layer through the drain electrode of the TFT, for example. In such a case, the semiconductor layer constitutes the “first conductive layer,” the gate insulating layer and the first interlayer insulating layer constitute the “first insulating layer,” the drain electrode constitutes the “second conductive layer,” the third interlayer insulating layer constitutes the “second insulating layer,” and the pixel electrode constitutes the “third conductive layer.” A configuration may be used in which the edge of the third TFT contact hole (second contact hole) in the third interlayer insulating layer is interposed between the step section that is raised onto the edge of the first TFT contact hole (first contact hole) at the drain electrode and the TFT contact section at the pixel electrode.

(2) In the embodiments above, an FFS-type liquid crystal panel was described as an example, but the present invention is also naturally applicable to an IPS-type liquid crystal panel. In an IPS-type liquid crystal panel, the opposite electrodes and the pixel electrodes provided on the array substrate are in the same layer, and thus, an electric field in a direction parallel to the surface of the substrate is applied to the liquid crystal layer. Thus, in an IPS-type device, the opposite electrodes and the pixel electrodes are both the “third conductive layer,” and therefore, characteristic configurations of the present invention can be applied to a part that connects the pixel electrode to the semiconductor layer through the drain electrode, and a part that connects the opposite electrodes to the common wiring lines through the contact electrodes.

(3) Besides (2), the present invention is applicable to a VA (vertical alignment) liquid crystal panel.

(4) In the embodiments above, a case was described in which only the pixel electrodes and not the opposite electrode were provided with slits, but slits may also be provided in the opposite electrode. In such a case, it is preferable that the slits formed in the opposite electrode intersect perpendicularly with the slits formed in the pixel electrodes.

(5) In the embodiments above, a case was described in which only the pixel electrodes and not the opposite electrode were provided with slits, but slits may be formed only in the opposite electrode.

(6) In the embodiments above, a case in which the opposite electrode is provided in a lower layer and the pixel electrodes are provided in an upper layer was described, but the present invention is also applicable to a case in which the layers are reversed such that the pixel electrodes are provided in a lower layer and the opposite electrode is provided in an upper layer.

(7) In the embodiments above, an array substrate having top gate (staggered type, forward staggered type) TFTs was described, but the present invention is also applicable to an array substrate having bottom gate (reverse staggered) TFTs.

(8) In the embodiments above, a case was described in which the semiconductor layer in the TFT is made of p-Si, but a-Si (amorphous silicon) may be used instead.

(9) In the embodiments above, the first contact section has a greater area than the second contact section, but it is possible to have a configuration in which the first contact section and the second contact section have approximately the same area, for example.

(10) In the embodiments above, the edge of the second contact hole covers the entire step section, but a configuration in which the edge of the second contact hole partially covers the step section is also included in the present invention.

(11) In the embodiments above, the step section is raised up from the entire outer edge of the first contact section, but a configuration can be used in which the step section is raised up from only a portion of the outer edge of the first contact section. Even in such a case, it is preferable that the entire step section be covered by the edge of the second contact hole.

(12) In the embodiments above, the center of the first contact hole matches the center of the second contact hole, but the present invention also includes a configuration in which the center of the first contact hole is offset from the center of the second contact hole.

(13) In the embodiments above, the center of the first contact section matches the center of the second contact section, but the present invention also includes a configuration in which the center of the first contact section is offset from the center of the second contact section.

(14) In the embodiments above, a case was described in which the second interlayer insulating layer is made of an organic material, but the second insulating layer can be made of an inorganic material or the like.

(15) In the embodiments above, the gate insulating layer, the first interlayer insulating layer, and the third interlayer insulating layer are all made of an inorganic material, but it is possible to make at least one or all of these of an organic material.

(16) In the embodiments above, the edge of the second contact hole in the second interlayer insulating layer has an arc shape in a cross-sectional view, but it is possible to have a curved shape such as a wave shape. Additionally, it is possible to provide the edge of the second contact hole with a tapered cross-sectional shape.

(17) In the embodiments above, the contact holes (contact sections) and the contact electrodes are square in a plan view, but it is possible to make the shape thereof be a rectangle, a non-quadrilateral polygon, a circle, an ellipse, or the like, for example.

(18) In the embodiments above, the contact electrode juts out from the common wiring line and a pad section is therefore formed in the common wiring line, but if the contact electrode fits within the width of the common wiring line and does not jut out, it is possible to omit the pad section in the common wiring line.

(19) The present invention is also applicable to liquid crystal display devices of the embodiments above, further including a touch panel.

(20) The present invention is applicable to liquid crystal display devices of the embodiments above, further including a parallax barrier (switching liquid crystal panel) in order to attain 3D display.

(21) The present invention is applicable to liquid crystal display devices of the embodiments above, further including a tuner to receive a television signal, or in other words, a television receiver.

(22) In the embodiments above, small- or mid-sized liquid crystal panels were described as examples, but the present invention is applicable to liquid crystal panels that are large or ultra-large.

(23) In the embodiments above, a manufacturing method for an array substrate included in a liquid crystal panel was described, but besides the liquid crystal panel, the present invention is also applicable to an EL display device, a plasma display device, or the like that includes TFTs for driving pixels, for example.

### DESCRIPTION OF REFERENCE CHARACTERS

11 liquid crystal panel (display element)
20 array substrate (substrate)
24 TFT
25,125 pixel electrode (fourth conductive layer)
25a slit
28 gate electrode
29 source electrode
30 drain electrode
31,131 common wiring line (first conductive layer)
32,132 opposite electrode (third conductive layer)
37 semiconductor layer
39 first interlayer insulating layer (first insulating layer)
39b, 139b first contact hole
40,140 second interlayer insulating layer (second insulating layer)
40b, 140b second contact hole
40b1, 140b1 edge
41 third interlayer insulating layer (third insulating layer)
42,142 contact electrode (second conductive layer)
42a, 142a first contact section
42b, 142b step section
43a, 143a second contact section

1. A display element, comprising:
a substrate;
a first conductive layer provided on the substrate;
a first insulating layer provided over the first conductive layer and having a first contact hole;
a second conductive layer provided over the first insulating layer, the second conductive layer being connected to the first conductive layer through the first contact hole and having a step section raised onto an edge of the first contact hole;
a second insulating layer provided over the second conductive layer and having a second contact hole positioned over the first contact hole; and
a third conductive layer provided over the second insulating layer and connected to the second conductive layer through the second contact hole,
wherein the second insulating layer is configured such that an edge of the second contact hole is interposed between the step section of the second conductive layer and the third conductive layer.

2. The display element according to claim 1,
wherein the second conductive layer has a flat first contact section in contact with the first conductive layer, whereas the third conductive layer has a flat second contact section in contact with the first contact section, and
wherein the first contact section is larger in area than the second contact section.

3. The display element according to claim 2, wherein the second insulating layer is configured such that the edge of the second contact hole covers the entire step section.

4. The display element according to claim 3,
wherein the step section is raised up from an entire edge of the first contact section.

5. The display element according to claim 2,
wherein the step section is raised up from an edge of the first contact section such that portions of the step section face each other, and
wherein the second contact section is disposed on the first contact section in a center between the portions of the step section facing each other.

6. The display element according to claim 5, wherein the second contact section is disposed such that a center thereof matches a center of the first contact section.

7. The display element according to claim 1, wherein the second insulating layer is made of an organic material.

8. The display element according to claim 1, wherein the second insulating layer is configured such that the edge of the second contact hole has a curved shape in a cross-sectional view.

9. The display element according to claim 1, further comprising a third insulating layer disposed on the third conductive layer and a fourth conductive layer disposed on the third insulating layer.

10. The display element according to claim 9, wherein at least one of the third conductive layer and the fourth conductive layer has a slit therein.

11. The display element according to claim 10, wherein the third conductive layer and the fourth conductive layer are both made of a transparent conductive material.

12. The display element according to claim 11, wherein the transparent conductive material is indium tin oxide.

13. The display element according to claim 10, wherein the third conductive layer constitutes an opposite electrode, whereas the fourth conductive layer constitutes a pixel electrode.

14. The display element according to claim 13, wherein the first conductive layer is a common wiring line that supplies a reference potential to the opposite electrode that is the third conductive layer through the second conductive layer.

15. The display element according to claim 14, wherein the common wiring line is made of a light-shielding metal.

16. The display element according to claim 13, further comprising a TFT constituted of a drain electrode connected to the pixel electrode that is the fourth conductive layer, a semiconductor layer having one end connected to the drain electrode, a source electrode connected to another end of the semiconductor layer, and a gate electrode that applies a gate voltage to the semiconductor layer,
wherein the second conductive layer is made of the same material as the drain electrode and the source electrode.
